(19) United States
(12) Patent Application Publication
(10) Pub. No.: US 2026/0303633 A1
(43) Pub. Date: Oct. 1, 2026

(54) METHOD AND SYSTEM FOR IDENTIFYING ARTIFICIAL INTELLIGENCE AGENTS

(71) Applicant: JPMorgan Chase Bank, N.A., New York, NY (US)

(72) Inventors: Jayaprakash MOSES, Greenville, DE (US); Venkata Mohit TAMANAMPUDI, New Castle, DE (US)

(73) Assignee: JPMorgan Chase Bank, N.A., New York, NY (US)

(21) Appl. No.: 19/468,765

(22) Filed: Feb. 3, 2026

Related U.S. Application Data
(60) Provisional application No. 63/778,105, filed on Mar. 26, 2025.

(51) Int. Cl. H04L 9/40

(52) U.S. Cl. CPC H04L 63/1425; H04L 63/1441

(57) ABSTRACT

A method and a system for identifying artificial intelligence (AI) agents are provided. The method includes: receiving input data within a system; analyzing the input data to detect a port, a uniform resource locator (URL), and/or a script; detecting communication between the port, at least one AI agent, and at least one large language model (LLM); analyzing an AI agent process and/or an LLM process; monitoring active user sessions within the system; analyzing system threads to identify threads associated with the at least one AI agent and/or the at least one LLM; identifying a presence of AI agents based on each of the analyzing, detecting, and monitoring operations; assessing the identified presence of AI agents to identify each AI agent associated with the system.

### CROSS-REFERENCE TO RELATED APPLICATIONS

This application claims priority benefit from U.S. Provisional Application No. 63/778,105, filed on Mar. 26, 2025, in the U.S. Patent and Trademark Office, which is hereby incorporated by reference in its entirety.

### FIELD OF THE DISCLOSURE

This disclosure generally relates to methods and systems for identifying artificial intelligence (AI) agents, and more particularly to methods and systems for analyzing a series of components and processes to detect the presence of one or more AI agents for accurately identifying all AI agents within a software-based system.

### BACKGROUND INFORMATION

In recent years, the proliferation of AI technologies has transformed the landscape of software development, enabling applications to perform complex tasks with unprecedented efficiency and accuracy. From natural language processing and image recognition to predictive analytics and autonomous decision-making, AI components are increasingly embedded within software systems across diverse industries. However, the integration of AI also introduces new challenges, particularly in terms of transparency, security, and compliance. As AI-driven applications become more prevalent, there is a growing need for tools that can identify and analyze the presence of AI agents within software programs.

The current state of vendor software is not sufficiently advanced to reliably detect and identify all AI agents embedded within AI models/applications. This lack of maturity in AI agent detection poses significant challenges, as AI agents possess capabilities that can have profound implications for system security and integrity.

AI agents, by their nature, can connect to databases, run scripts, and execute commands autonomously. While these capabilities enable powerful functionalities, they also introduce potential risks. AI agents can inadvertently or maliciously access sensitive information, execute unauthorized scripts, or perform dangerous commands that compromise system security. The inability of existing vendor software to effectively identify and monitor these AI agents exacerbates the risk of unintended consequences and security breaches.

The problem is further compounded by the lack of transparency and understanding of AI components within software systems. Without robust detection mechanisms, organizations are left vulnerable to the hidden activities of AI agents, which can lead to data breaches, unauthorized access, and other security threats. Addressing this problem requires the development of advanced tools capable of accurately identifying AI agents and assessing their potential impact on software environments.

Accordingly, there is a need for a system that can identify and analyze the presence of AI agents within software programs. Particularly, a method and system are needed for analyzing a diverse series of components and processes to detect the presence of one or more AI agents for accurately identifying all AI agents within a software-based system.

### SUMMARY

The present disclosure, through one or more of its various aspects, embodiments, and/or specific features or sub-components, provides, inter alia, various systems, servers, devices, methods, media, programs, and platforms for analyzing a series of components and processes to detect the presence of one or more AI agents for accurately identifying all AI agents within a software-based system.

According to an aspect of the present disclosure, a method for identifying AI agents is provided. The method may be implemented by at least one processor. The method may include: receiving, by the at least one processor, input data within a system, wherein the input data includes at least one from among user data and system data; analyzing, by the at least one processor, the input data to detect at least one from among a port, a uniform resource locator (URL), and a script; identifying, by the at least one processor, a first AI agent presence based on the analyzing of the input data; detecting, by the at least one processor, communication between the port, at least one AI agent, and at least one large language model (LLM); identifying, by the at least one processor, a second AI agent presence based on the detecting of the communication; analyzing, by the at least one processor, at least one from among an AI agent process and an LLM process; identifying, by the at least one processor, a third AI agent presence based on the analyzing of the at least one from among the AI agent process and the LLM process; monitoring, by the at least one processor, active user sessions within the system; identifying, by the at least one processor, a fourth AI agent presence based on the monitoring of the active user sessions; analyzing, by the at least one processor, system threads to identify threads associated with at least one from among the at least one AI agent and the at least one LLM; identifying, by the at least one processor, a fifth AI agent presence based on the analyzing of the system threads; and assessing, by the at least one processor, the first AI agent presence, the second AI agent presence, the third AI agent presence, the fourth AI agent presence, and the fifth AI agent presence to identify each AI agent associated with the system.

The method may further include: transmitting, by the at least one processor, a result of the assessing to a database for storage; and generating, by the at least one processor, a report based on the transmitted result.

The report may include a listing of detected AI components, functionalities of the detected AI components, and a potential threat associated with the detected AI components.

The method may further include generating, by the at least one processor, a recommendation for mitigating the potential threat associated with the detected AI components.

The method may further include identifying, by the at least one processor, a potential risk from at least one from among an unsecured script associated with the script, data leakage from the database, and external data.

The analyzing of the at least one from among the AI agent process and the LLM process may include using tracing techniques to examine the AI agent process and the LLM process for the identifying of the third AI agent presence.

The monitoring of active user sessions may include detecting an interaction involving each AI agent and each LLM.

The analyzing of the system threads may use tracing techniques to determine whether the system threads are associated with at least one from among the at least one AI agent and the at least one LLM.

According to another aspect of the present disclosure, a computing apparatus for performing endpoint device recovery is provided. The computing apparatus may include a processor; a memory; and a communication interface coupled to each of the processor, and the memory. The processor may be configured to: receive input data within a system, wherein the input data includes at least one from among user data and system data; analyze the input data to detect at least one from among a port, a uniform resource locator (URL), and a script; identify a first AI agent presence based on the analyzing of the input data; detect communication between the port, at least one AI agent, and at least one large language model (LLM); identify a second AI agent presence based on the detecting of the communication; analyze at least one from among an AI agent process and an LLM process; identify a third AI agent presence based on the analyzing of the at least one from among the AI agent process and the LLM process; monitor active user sessions within the system; identify a fourth AI agent presence based on the monitoring of the active user sessions; analyze system threads to identify threads associated with at least one from among the at least one AI agent and the at least one LLM; identify a fifth AI agent presence based on the analyzing of the system threads; and assess the first AI agent presence, the second AI agent presence, the third AI agent presence, the fourth AI agent presence, and the fifth AI agent presence to identify each AI agent associated with the system.

The processor may be further configured to: transmit a result of the assessing to a database for storage; and generate a report based on the transmitted result.

The report may include a listing of detected AI components, functionalities of the detected AI components, and a potential threat associated with the detected AI components.

The processor may be further configured to generate a recommendation for mitigating the potential threat associated with the detected AI components.

The processor may be further configured to identify a potential risk from at least one from among an unsecured script associated with the script, data leakage from the database, and external data.

The analyzing of the at least one from among the AI agent process and the LLM process may include using tracing techniques to examine the AI agent process and the LLM process for the identifying of the third AI agent presence.

The monitoring of active user sessions may include detecting an interaction involving each AI agent and each LLM.

The analyzing of the system threads may use tracing techniques to determine whether the system threads are associated with at least one from among the at least one AI agent and the at least one LLM.

According to yet another aspect of the present disclosure, a non-transitory computer readable storage medium storing instructions for identifying artificial intelligence (AI) agents is provided. The storage medium includes executable code which, when executed by a processor, may cause the processor to: receive input data within a system, wherein the input data includes at least one from among user data and system data; analyze the input data to detect at least one from among a port, a uniform resource locator (URL), and a script; identify a first AI agent presence based on the analyzing of the input data; detect communication between the port, at least one AI agent, and at least one large language model (LLM); identify a second AI agent presence based on the detecting of the communication; analyze at least one from among an AI agent process and an LLM process; identify a third AI agent presence based on the analyzing of the at least one from among the AI agent process and the LLM process; monitor active user sessions within the system; identify a fourth AI agent presence based on the monitoring of the active user sessions; analyze system threads to identify threads associated with at least one from among the at least one AI agent and the at least one LLM; identify a fifth AI agent presence based on the analyzing of the system threads; and assess the first AI agent presence, the second AI agent presence, the third AI agent presence, the fourth AI agent presence, and the fifth AI agent presence to identify each AI agent associated with the system.

The executable code may further cause the processor to: transmit a result of the assessing to a database for storage; and generate a report based on the transmitted result.

The report may include a listing of detected AI components, functionalities of the detected AI components, and a potential threat associated with the detected AI components.

The executable code may further cause the processor to generate a recommendation for mitigating the potential threat associated with the detected AI components.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for analyzing a series of components and processes to detect the presence of one or more AI agents for accurately identifying all AI agents within a software-based system, according to an embodiment.

FIG. 2 illustrates a diagram of a network environment for analyzing a series of components and processes to detect the presence of one or more AI agents for accurately identifying all AI agents within a software-based system, according to an embodiment.

FIG. 3 illustrates a system diagram of a system for analyzing a series of components and processes to detect the presence of one or more AI agents for accurately identifying all AI agents within a software-based system, according to an embodiment.

FIG. 4 illustrates a process diagram of a process for analyzing a series of components and processes to detect the presence of one or more AI agents for accurately identifying all AI agents within a software-based system, according to an embodiment.

FIG. 5 illustrates a system diagram for analyzing a series of components and processes to detect the presence of one or more AI agents for accurately identifying all AI agents within a software-based system, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein performs a series of operations for identifying AI agents within software-based systems. Particularly, the system may analyze various input data, processes, and components in order to identify all AI agents associated with the system. For example, the system may analyze input data to detect each port, URL, and script associated with the software-based system. The system then identifies the presence of AI agents within the detected ports, URLs, and scripts. The system may then analyze and detect communication between each port, AI agent, and LLM within the software-based system to further identify the presence of AI agents. Next, the system may analyze each AI agent and LLM process for identifying an additional presence of AI agents. Also, the system may monitor active user sessions within the software-based system for further identifying the presence of AI agents. Additionally, the system may analyze system threads within the software-based system to identify each thread associated with an AI agent and/or LLM, and identify the presence of AI agents. Then, the system may analyze and compile the results from each identification of the presence of AI agents to provide a comprehensive assessment and report each identified AI agent within the software-based system.

By utilizing this comprehensive analysis and identification strategy for AI detection, the system contributes to the responsible and secure deployment of AI technologies in modern software development. Particularly, the system offers several key benefits that address the challenges associated with identifying and managing AI components within software applications. For example, the system enhances security by detecting AI agents that can connect to databases, run scripts, and execute commands, to help prevent unauthorized access and potential security breaches. This provides an additional layer of protection against malicious activities that could compromise system integrity. Moreover, the system also improves transparency by providing insights into the AI components embedded within software-based systems, offering a clearer understanding of their functionalities and behaviors. This transparency is crucial for stakeholders to make informed decisions about AI integration and management. Additionally, the system helps with regulatory compliance. Particularly, as regulations around AI usage and data protection become more stringent, the system assists organizations in ensuring compliance with industry standards and legal requirements. It helps identify AI components that may need to be audited or monitored for compliance purposes.

The system also improves risk mitigation by identifying potential threats associated with AI agents, which enables organizations to proactively address risks before they escalate. This includes mitigating the risk of data leaks, unauthorized command execution, and other security vulnerabilities. Moreover, the system improves operational efficiency by streamlining the process of identifying and analyzing AI components, which reduces the time and effort required for manual inspection. This efficiency allows organizations to focus resources on other critical areas of development and security. Also, the system enables informed decision-making. Particularly, by providing detailed insights into the presence and capabilities of AI agents, decision-makers can better assess the impact of AI technologies on their systems. This information supports strategic planning and resource allocation for AI-related projects. Additionally, the system provides facilitated auditing and monitoring, which aids in the continuous monitoring and auditing of AI components, ensuring that any changes or updates to AI functionalities are tracked and assessed for potential risks. Overall, the system provides a comprehensive solution for managing the complexities and risks associated with AI integration in software applications, contributing to a more secure and transparent technological environment.

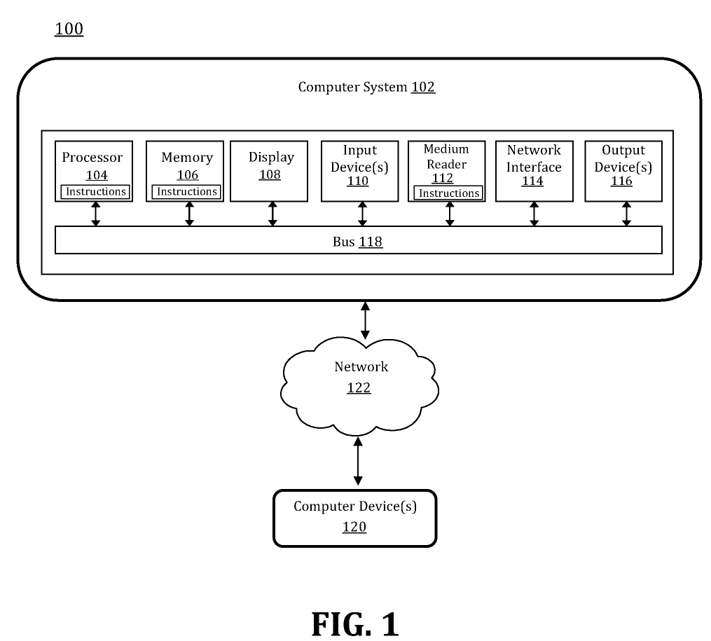

FIG. 1 is a system 100 for analyzing a series of components and processes to detect the presence of one or more AI agents for accurately identifying all AI agents within a software-based system, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120, as shown in FIG. 1, may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the AI agent detector module implemented by the system 100 may allow for analyzing a series of components and processes to detect the presence of one or more AI agents for accurately identifying all AI agents within a software-based system. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

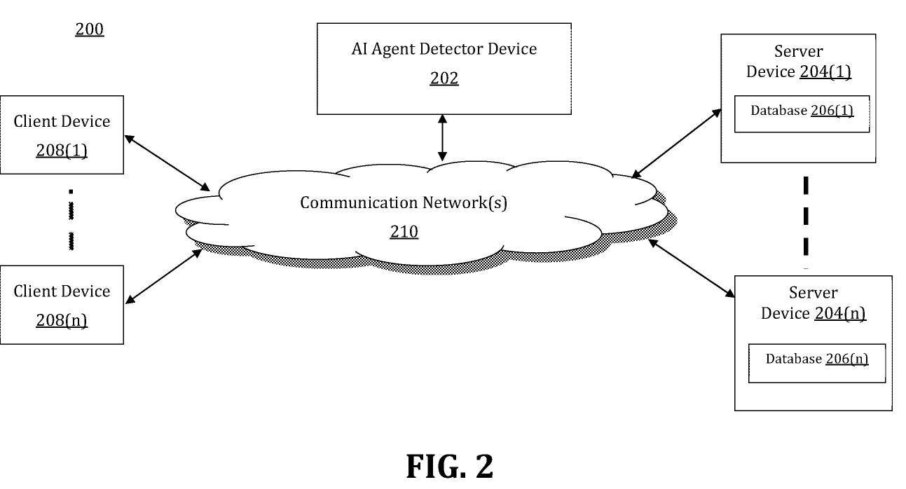

Referring to FIG. 2, a schematic of a network environment 200 for analyzing a series of components and processes to detect the presence of one or more AI agents for accurately identifying all AI agents within a software-based system is illustrated.

In some embodiments, the above-described problems associated with conventional tools may be overcome by implementing an AI agent detector device 202 as illustrated in FIG. 2 that may be configured for analyzing a series of components and processes to detect the presence of one or more AI agents for accurately identifying all AI agents within a software-based system, but the disclosure is not limited thereto.

The AI agent detector device 202 may include one or more computer systems 102, as described with respect to FIG. 1, which in aggregate provide the necessary functions.

The AI agent detector device 202 may store one or more applications that can include executable instructions that, when executed by the AI agent detector device 202, cause the AI agent detector device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AI agent detector device 202 itself, may be located in virtual server(s) running in a cloud-based computing environment rather than being tied to one or more specific physical network computing devices. Also, the application(s) may be running in one or more virtual machines (VMs) executing on the AI agent detector device 202. Additionally, in one or more embodiments of this technology, virtual machine(s) running on the AI agent detector device 202 may be managed or supervised by a hypervisor.

In the network environment 200 of FIG. 2, the AI agent detector device 202 may be coupled to a plurality of server devices 204(1)-204(n) that hosts a plurality of databases 206(1)-206(n), and also to a plurality of client devices 208(1)-208(n) via communication network(s) 210. A communication interface of the AI agent detector device 202, such as the network interface 114 of the computer system 102 of FIG. 1, operatively couples and communicates between the AI agent detector device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AI agent detector device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AI agent detector device 202 may be a standalone device or integrated with one or more other devices or apparatuses, such as one or more of the server devices 204(1)-204(n), for example. In one example, the AI agent detector device 202 may be hosted by one of the server devices 204(1)-204(n), and other arrangements are also possible. Moreover, one or more of the devices of the AI agent detector device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AI agent detector device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the AI agent detector device 202 that may analyze a series of components and processes to detect the presence of one or more AI agents for accurately identifying all AI agents within a software-based system, but the disclosure is not limited thereto.

The client devices 208(1)-208(n) may run interface applications, such as standard web browsers or standalone client applications, which may provide an interface to communicate with the AI agent detector device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the AI agent detector device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the AI agent detector device 202, the server devices 204(1)-204(n), or the client devices 208(1)-208(n), for example, may be configured to operate as virtual instances on the same physical machine. For example, one or more of the AI agent detector devices 202, the server devices 204(1)-204(n), or the client devices 208(1)-208(n) may operate on the same physical device rather than as separate devices communicating through communication network(s) 210. Additionally, there may be more or fewer AI agent detector devices 202, server devices 204(1)-204(n), or client devices 208(1)-208(n) than illustrated in FIG. 2. In some embodiments, the AI agent detector device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

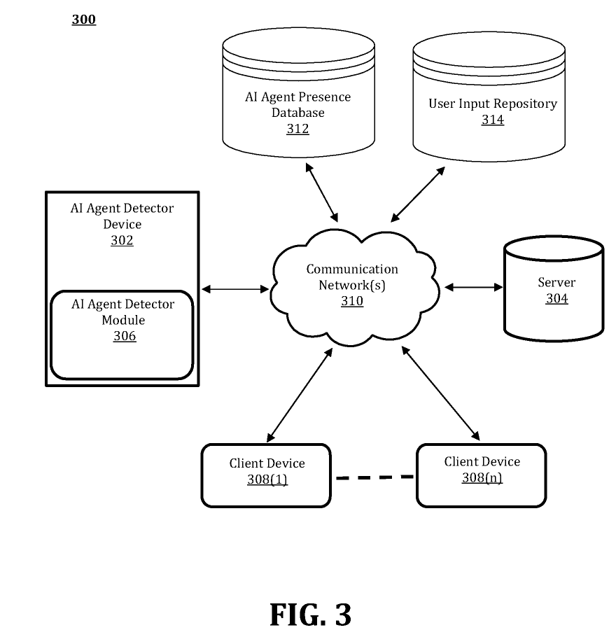

FIG. 3 illustrates a system diagram for analyzing a series of components and processes to detect the presence of one or more AI agents for accurately identifying all AI agents within a software-based system, in accordance with an embodiment.

As illustrated in FIG. 3, the system 300 may include an AI agent detector device 302 within which an AI agent detector module 306 is embedded, a server 304, an AI agent presence database 312, a user input repository 314, a plurality of client devices 308(1) … 308(n), and a communication network 310.

In some embodiments, the AI agent detector device 302 including the AI agent detector module 306 may be connected to the server 304, the AI agent presence database 312, and the user input repository 314 via the communication network 310. The AI agent detector device 302 may also be connected to the plurality of client devices 308(1) … 308(n) via the communication network 310, but the disclosure is not limited thereto. The AI agent presence database 312 and the user input repository 314 may include one or more repositories or databases.

In an embodiment, the AI agent detector device 302 is described and shown in FIG. 3 as including the AI agent detector module 306, although it may include other rules, policies, modules, databases, or applications, for example. In some embodiments, the AI agent presence database 312 and the user input repository 314 may be configured to store ready to use modules written for each API for all environments. Although only one database is illustrated in FIG. 3, the disclosure is not limited thereto. Any number of desired databases and/or repositories may be utilized for use in the disclosed invention herein. Each of the AI agent presence database 312 and the user input repository 314 may be a mainframe database, a log database that may produce programming for searching, monitoring, and analyzing machine-generated data via a web interface, but the disclosure is not limited thereto. In addition, the AI agent presence database 312 and the user input repository 314 may store a plurality of applications and resources for identifying AI agents.

In some embodiments, the AI agent detector module 306 may be configured to receive a real-time feed of data from the plurality of client devices 308(1) … 308(n) and secondary sources via the communication network 310.

The AI agent detector module 306 may be configured to: receive input data within a system, wherein the input data includes at least one from among user data and system data; analyze the input data to detect at least one from among a port, a URL, and a script; identify a first AI agent presence based on the analyzing of the input data; detect communication between the port, at least one AI agent, and at least one LLM; identify a second AI agent presence based on the detecting of the communication; analyze at least one from among an AI agent process and an LLM process; identify a third AI agent presence based on the analyzing of the at least one from among the AI agent process and the LLM process; monitor active user sessions within the system; identify a fourth AI agent presence based on the monitoring of the active user sessions; analyze system threads to identify threads associated with at least one from among the at least one AI agent and the at least one LLM; identify a fifth AI agent presence based on the analyzing of the system threads; and assess the first AI agent presence, the second AI agent presence, the third AI agent presence, the fourth AI agent presence, and the fifth AI agent presence to identify each AI agent associated with the system.

The plurality of client devices 308(1) … 308(n) are illustrated as being in communication with the AI agent detector device 302. In this regard, the plurality of client devices 308(1) … 308(n) may be “clients” (e.g., customers) of the AI agent detector device 302 and are described herein as such. Nevertheless, it is to be known and understood that the plurality of client devices 308(1) … 308(n) need not necessarily be “clients” of the AI agent detector device 302, or any entity described in association therewith herein. Any additional or alternative relationship may exist between either or both plurality of client devices 308(1) … 308(n) and the AI agent detector device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) … 308(n) may communicate with the AI agent detector device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The AI agent detector device 302 may be the same or similar to the AI agent detector device 202 as described with respect to FIG. 2, including any features or combination of features described with respect thereto.

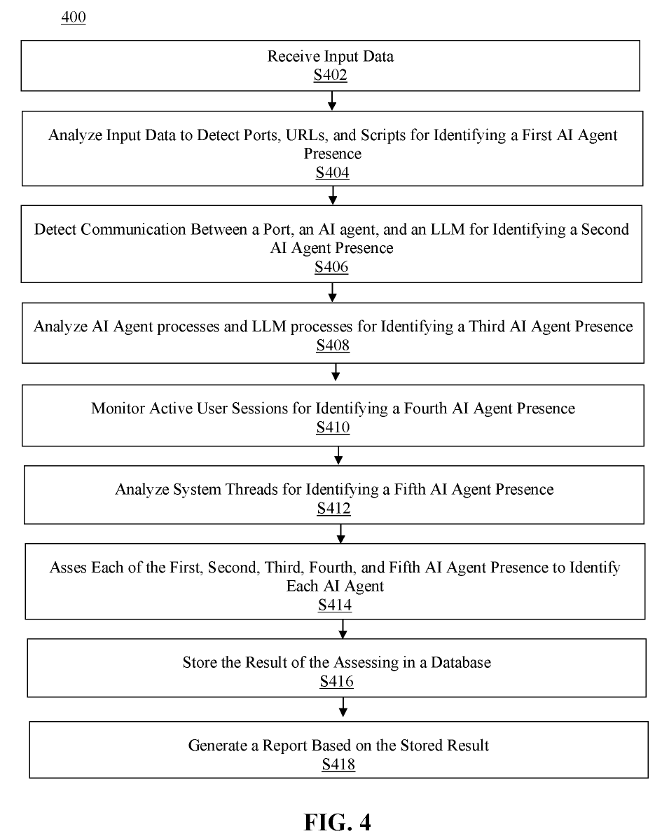

FIG. 4 illustrates a process 400 for analyzing a series of components and processes to detect the presence of one or more AI agents for accurately identifying all AI agents within a software-based system, according to an embodiment.

In process 400 of FIG. 4, at step S402, the AI agent detector device 302 may receive input data. The input data may include user data and/or system data. The user data may be a user input that corresponds to a user prompt or query (e.g., “what is my Jira completion rate?”). The system input may be a prompt or command for executing a function within a software-based system (e.g., “run the function ‘Jira calculator’”). In an embodiment, the receiving of input data may be initiated by a scanning process that begins at an input module, which receives the user and system data from the user input.

At step S404, the AI agent detector device 302 may analyze the input data to detect at least one from among a port, a URL, and a script. Based on the analysis, the AI agent detector device 302 may identify a presence of AI agents (i.e., a first AI agent presence) within the software-based system. In an embodiment, the analysis may be performed by a text detector module. The data may be transferred from the input module to the text detector module, which scans for port numbers, URLs, or any scripts to execute. The primary function of the text detector module may be to analyze the incoming data to determine the presence of any AI agents within the input system.

At step S406, the AI agent detector device 302 may detect communication between ports, AI agents, and LLMs. Based on the detected communication, the AI agent detector device 302 may further identify the presence of AI agents (i.e., a second AI agent presence) within the software-based system. In some embodiments, this communication detecting operation may be performed by a port detector module that is responsible for monitoring network port communications. The AI agent detector device 302, including the port detector module, may detect any input from the LLM and AI agents and examine network ports to identify any active communication between the ports, the LLM, and AI agents. This ensures that all interactions involving the LLM and AI agents are tracked through any specific port, helping to identify the presence of AI Agents.

At step S408, the AI agent detector device 302 may analyze each AI agent process and/or each LLM process within a software-based system. Based on this analysis, the AI agent detector device 302 may further identify the presence of AI agents (i.e., a third AI agent presence) within the software-based system. In an embodiment, the analysis may be performed by a process detector module that identifies and examines any processes that are associated with AI agents or the LLM. The AI agent detector device 302, including the process detector module, may use tracing techniques to associate the AI Agents and the LLM. By scrutinizing process behavior, the AI agent detector device 302 is further able to help identify the presence of AI Agents.

At step S410, the AI agent detector device 302 may monitor active user sessions within the software-based system. Based on this monitoring, the AI agent detector device 302 may further identify the presence of AI agents (i.e., a fourth AI agent presence) within the software-based system. In an embodiment, the monitoring may be performed by a session detector module that focuses on monitoring active user sessions within the system by analyzing user sessions to detect any interactions involving AI agents or the LLM. By maintaining oversight of session activities, the AI agent detector device 302, including the session detector module, helps to identify the presence of AI Agents if there is any interaction with the LLM/AI Agents.

At step S412, the AI agent detector device 302 may analyze system threads within the software-based system to further identify the presence of AI agents (i.e., a fifth AI agent presence). In an embodiment, this analysis may be performed by a thread detector module that is tasked with monitoring and analyzing any system threads by identifying and examining any threads that are associated with AI agents or the LLM. The AI agent detector device 302, including the process detector module, may use tracing techniques to associate AI Agents and the LLM. By scrutinizing thread behavior, the AI agent detector device 302 may help identify the presence of AI Agents.

At step S414, the AI agent detector device 302 may assess each identified presence of AI agents (i.e., the first, second, third, fourth, and fifth AI agent presence) to identify each AI agent associated with the software-based system. In an embodiment, the assessment may be performed by an AI detection engine that receives the analysis results from all the subsequent modules. The AI agent detector device 302, including the AI detection engine, then identifies the presence of AI agents based on the identified patterns, structures, signatures, and/or behaviors. In some embodiments, the detection results may be sent to a database.

At step S416, the AI agent detector device 302 may store the results of the assessment within the database. The database may store the detection results for future reference and to help improve the system's detection capabilities. The stored results may be passed to a reporting module.

Then, at step S418, the AI agent detector device 302 may generate a report based on the stored results. In an embodiment, the generating of the report may be performed by the reporting module. The report may detail the AI components detected, their functionalities, and potential threats. The report may be sent to a firm's security team. In some embodiments, the AI agent detector device 302 may generate a recommendation for mitigating the potential threats associated with the detected AI components. In an embodiment, the AI agent detector device 302 may identify a potential risk from an unsecured script associated with the script, data leakage from the database, and/or external data.

In some embodiments, the AI agent detector device 302 may be used in a variety of uses cases, including: collecting AI agent inventory, identifying threats from unsecured scripts, identifying threats from data leakage from the database; identifying threats of external data; identifying AI agents integrated with external systems; and identifying AI agents connected to external systems.

Additionally, the AI agent detector device 302 may be able to track which system, region, and user system the AI agent is coming from. Then, based on this information, the AI agent detector device 302 may be able to provide additional details about each identified AI agent including what software language the AI agent is using and the current version of the AI agent. In some embodiments, the AI agent detector device may be configured to run in the background of software systems to perform the identifying of AI agents without any prompt or facilitating by a user. In this scenario, the AI agent identification results may be automatically transmitted to a cyber security system. Moreover, once the AI agents are identified the AI agent detector device 302 may be further used in tracking and rectifying the vulnerabilities of these AI agents to enhance the security and stability of the system.

The AI agent detector device 302 may analyze a series of components and processes to detect the presence of one or more AI agents for accurately identifying all AI agents within a software-based system. An AI agent may be a software entity that performs tasks autonomously using AI techniques between users and an LLM. An AI agent may perceive its environment through sensors, process the information, and take actions to achieve specific goals. AI agents can range from simple rule-based systems to complex models that use machine learning and deep learning to make decisions. They may be used in various applications, such as virtual assistants, autonomous vehicles, recommendation systems, and more. The key characteristics of an AI agent include autonomy, adaptability, and the ability to learn from experience.

As a user, the AI agent may operate by sending user input data, augmenting it with system input data, and then feeding it to the LLM. This approach can serve various functions such as implementing guardrails, enforcing security policies, and acting in specific roles like teacher, lawyer, developer, manager, trader, etc. It exemplifies a user data-based AI agent, where the agent's actions are guided by user interactions.

When AI agents operate as an LLM, the LLM may communicate with a variety of entities, including intranet and internet resources, functions, databases, APIs, scripts, and more. This capability allows the LLM to interact seamlessly with different systems and components, facilitating a wide range of functionalities and integrations. By engaging with these diverse entities, the LLM can enhance its operational scope and provide more comprehensive solutions.

This dual communication capability highlights the versatility of AI agents in interacting with both user inputs and system-level processes, ensuring comprehensive functionality and adaptability.

In an embodiment, the AI agent detector device 302 may operate as a specialized tool or system designed to identify and analyze the presence and activities of AI agents within a software environment. Its primary function may be to monitor various components of a system to detect AI-driven processes, communications, and interactions.

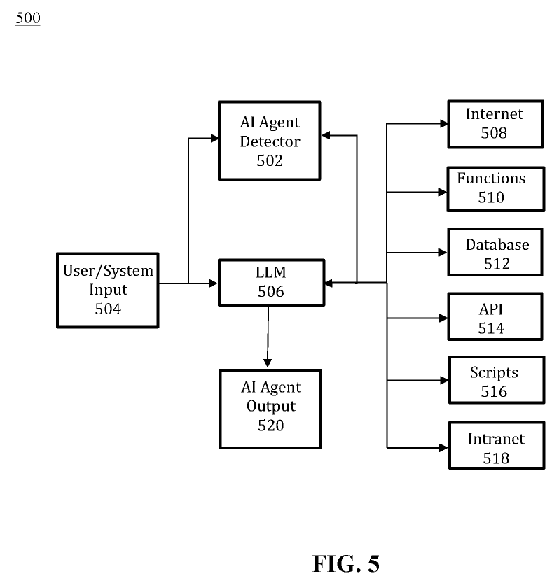

FIG. 5 illustrates a system diagram 500 for analyzing a series of components and processes to detect the presence of one or more AI agents for accurately identifying all AI agents within a software-based system, according to an embodiment.

In process 500 of FIG. 5, a user/system input module 504 transmits input data, including a prompt or query, to the LLM 506. This input data is additionally received and analyzed by the AI agent detector 502. In an embodiment, the AI agent detector 502 may include a text difference detector module that analyzes the incoming data for determining if any changes have been made to the incoming data to determine the presence of AI agents. The text detector module may scan for port numbers, URLs, or any scripts to execute. The input data that is received by the LLM 506 is analyzed and then output to one or more of a plurality of tools and modules, including the internet 508, a functions module 510, a database 512, an API 514, one or more scripts 516, and an intranet 518, for performing a series of tasks related to the prompt/query. Once each tool performs the appropriate tasks, the corresponding data is output back to the LLM. This communication going between each of the tools and the LLM 506 is also received and analyzed by the AI agent detector 502. Once all the data is analyzed and processed by the LLM 506, an AI agent output 520 is generated.

In some embodiments, the AI agent detector 502 may include a text detector module that analyzes the incoming data to determine the presence of any AI agents. The text detector module may scan for port numbers, URLs, or any scripts to execute. The AI agent detector 502 may also include a port detector module that detects any input from the LLM 506 and AI agents and examines network ports to identify any active communication between the ports, the LLM 506, and AI agents to help identify the presence of AI Agents. The AI agent detector 502 may also include a process detector module that identifies and examines any processes that are associated with AI agents or the LLM 506. By scrutinizing process behavior, the process detector module may help to identify the presence of AI Agents. The AI agent detector 502 may also include a session detector module that identifies and analyzes user sessions to detect any interactions involving AI agents or the LLM 506. By maintaining oversight of session activities, the session detector module may help to identify the presence of AI Agents if there is any interaction with the LLM 506 and/or AI Agents. The AI agent detector 502 may also include a thread detector module that identifies and examines any threads that are associated with AI agents or the LLM 506 by using tracing techniques to associate AI Agents and the LLM 506. By scrutinizing the thread behavior, the thread detector module may help to identify the presence of AI Agents.

The AI agent detector device 302 and the associated scanning process represent a significant advancement in the management and governance of AI components within software-based systems. By providing a comprehensive tool for the detection, analysis, and reporting of AI agents, it addresses key challenges associated with AI integration, such as transparency, security, and compliance. The advantages include improved transparency, enhanced security, regulatory compliance, risk mitigation, operational efficiency, informed decision-making, and facilitated auditing and monitoring, which make it a valuable tool for any organization that uses AI in its software systems. The potential future applications of the AI agent detector device 302 are vast. From AI governance and ethics to cybersecurity, AI in IoT, and AI in autonomous systems, this tool has the potential to play a crucial role in ensuring the responsible and effective use of AI technologies. As AI continues to evolve and become more integrated into software systems, tools like the AI agent detector 302 will become increasingly important. By providing a robust and comprehensive solution for AI detection, this system contributes to a more secure, transparent, and responsible AI landscape.

Accordingly, with this technology, an optimized process for analyzing a series of components and processes to detect the presence of one or more AI agents for accurately identifying all AI agents within a software-based system is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for identifying artificial intelligence (AI) agents, the method being implemented by at least one processor, the method comprising:
receiving, by the at least one processor, input data within a system, wherein the input data includes at least one from among user data and system data;
analyzing, by the at least one processor, the input data to detect at least one from among a port, a uniform resource locator (URL), and a script;
identifying, by the at least one processor, a first AI agent presence based on the analyzing of the input data;
detecting, by the at least one processor, communication between the port, at least one AI agent, and at least one large language model (LLM);
identifying, by the at least one processor, a second AI agent presence based on the detecting of the communication;
analyzing, by the at least one processor, at least one from among an AI agent process and an LLM process;
identifying, by the at least one processor, a third AI agent presence based on the analyzing of the at least one from among the AI agent process and the LLM process;
monitoring, by the at least one processor, active user sessions within the system;
identifying, by the at least one processor, a fourth AI agent presence based on the monitoring of the active user sessions;
analyzing, by the at least one processor, system threads to identify threads associated with at least one from among the at least one AI agent and the at least one LLM;
identifying, by the at least one processor, a fifth AI agent presence based on the analyzing of the system threads; and
assessing, by the at least one processor, the first AI agent presence, the second AI agent presence, the third AI agent presence, the fourth AI agent presence, and the fifth AI agent presence to identify each AI agent associated with the system.

2. The method of claim 1, further comprising:
transmitting, by the at least one processor, a result of the assessing to a database for storage; and
generating, by the at least one processor, a report based on the transmitted result.

3. The method of claim 2, wherein the report includes a listing of detected AI components, functionalities of the detected AI components, and a potential threat associated with the detected AI components.

4. The method of claim 3, further comprising:
generating, by the at least one processor, a recommendation for mitigating the potential threat associated with the detected AI components.

5. The method of claim 2, further comprising:
identifying, by the at least one processor, a potential risk from at least one from among an unsecured script associated with the script, data leakage from the database, and external data.

6. The method of claim 1, wherein the analyzing of the at least one from among the AI agent process and the LLM process includes using tracing techniques to examine the AI agent process and the LLM process for the identifying of the third AI agent presence.

7. The method of claim 1, wherein the monitoring of active user sessions includes detecting an interaction involving each AI agent and each LLM.

8. The method of claim 1, wherein the analyzing of the system threads uses tracing techniques to determine whether the system threads are associated with at least one from among the at least one AI agent and the at least one LLM.

9. A computing apparatus for identifying artificial intelligence (AI) agents, the computing apparatus comprising:
a processor;
a memory; and
a communication interface coupled to each of the processor and the memory,
wherein the processor is configured to:
receive input data within a system, wherein the input data includes at least one from among user data and system data;
analyze the input data to detect at least one from among a port, a uniform resource locator (URL), and a script;
identify a first AI agent presence based on the analyzing of the input data;
detect communication between the port, at least one AI agent, and at least one large language model (LLM);
identify a second AI agent presence based on the detecting of the communication;
analyze at least one from among an AI agent process and an LLM process;
identify a third AI agent presence based on the analyzing of the at least one from among the AI agent process and the LLM process;
monitor active user sessions within the system;
identify a fourth AI agent presence based on the monitoring of the active user sessions;
analyze system threads to identify threads associated with at least one from among the at least one AI agent and the at least one LLM;
identify a fifth AI agent presence based on the analyzing of the system threads; and
assess the first AI agent presence, the second AI agent presence, the third AI agent presence, the fourth AI agent presence, and the fifth AI agent presence to identify each AI agent associated with the system.

10. The computing apparatus of claim 9, wherein the processor is further configured to:
transmit a result of the assessing to a database for storage; and
generate a report based on the transmitted result.

11. The computing apparatus of claim 10, wherein the report includes a listing of detected AI components, functionalities of the detected AI components, and a potential threat associated with the detected AI components.

12. The computing apparatus of claim 11, wherein the processor is further configured to:
generate a recommendation for mitigating the potential threat associated with the detected AI components.

13. The computing apparatus of claim 10, wherein the processor is further configured to:
identify a potential risk from at least one from among an unsecured script associated with the script, data leakage from the database, and external data.

14. The computing apparatus of claim 9, wherein the analyzing of the at least one from among the AI agent process and the LLM process includes using tracing techniques to examine the AI agent process and the LLM process for the identifying of the third AI agent presence.

15. The computing apparatus of claim 9, wherein the monitoring of active user sessions includes detecting an interaction involving each AI agent and each LLM.

16. The computing apparatus of claim 9, wherein the analyzing of the system threads uses tracing techniques to determine whether the system threads are associated with at least one from among the at least one AI agent and the at least one LLM.

17. A non-transitory computer readable storage medium storing instructions for identifying artificial intelligence (AI) agents, the storage medium comprising executable code which, when executed by a processor, causes the processor to:
receive input data within a system, wherein the input data includes at least one from among user data and system data;
analyze the input data to detect at least one from among a port, a uniform resource locator (URL), and a script;
identify a first AI agent presence based on the analyzing of the input data;
detect communication between the port, at least one AI agent, and at least one large language model (LLM);
identify a second AI agent presence based on the detecting of the communication;
analyze at least one from among an AI agent process and an LLM process;
identify a third AI agent presence based on the analyzing of the at least one from among the AI agent process and the LLM process;
monitor active user sessions within the system;
identify a fourth AI agent presence based on the monitoring of the active user sessions;
analyze system threads to identify threads associated with at least one from among the at least one AI agent and the at least one LLM;
identify a fifth AI agent presence based on the analyzing of the system threads; and
assess the first AI agent presence, the second AI agent presence, the third AI agent presence, the fourth AI agent presence, and the fifth AI agent presence to identify each AI agent associated with the system.

18. The storage medium of claim 17, wherein the executable code further causes the processor to:
transmit a result of the assessing to a database for storage; and
generate a report based on the transmitted result.

19. The storage medium of claim 18, wherein the report includes a listing of detected AI components, functionalities of the detected AI components, and a potential threat associated with the detected AI components.

20. The storage medium of claim 19, wherein the executable code further causes the processor to:
generate a recommendation for mitigating the potential threat associated with the detected AI components.
